(19) United States
(12) Patent Application Publication
(10) Pub. No.: US 2024/0230353 A1
(43) Pub. Date: Jul. 11, 2024

(54) Cost Based Navigation and Route Planning

(71) Applicant: Google LLC, Mountain View, CA (US)

(72) Inventors: Yan Mayster, Aurora, CO (US); Robert Bruce Bahnsen, Boulder, CO (US); Zhiyuan Weng, Superior, CO (US)

(21) Appl. No.: 17/928,385

(22) PCT Filed: Sep. 29, 2021
(86) PCT No.: PCT/US2021/052616

§ 371 Date: Apr. 6, 2023

(51) Int. Cl. G01C 21/34; G06Q 10/047

(52) U.S. Cl. CPC G01C 21/3476; G06Q 10/047

(57) ABSTRACT

Methods, systems, devices, and tangible non-transitory computer readable media for navigation and route planning are provided. The disclosed technology can include accessing request data including information associated with requests of a user. Based on the user requests, locations associated with satisfying the requests can be determined. Routes associated with the locations that satisfy the user requests can be determined. Completion costs respectively associated with satisfying the requests at the locations can be determined. Based on travel criteria, a travel route can be selected from the routes. The travel criteria can be associated with the completion costs of each of the routes. Output including indications associated with the travel route can be generated.

### FIELD

The present disclosure relates generally to navigation and in particular to a system for route generation that can include the use of costs to determine travel routes.

### BACKGROUND

Operations associated with navigation through a geographic area can be implemented on a variety of computing devices. These operations can include processing data associated with the geographic area in order to improve navigation. For example, different types of operations can be used to reduce travel time and find locations that more accurately match a user's search terms while at the same time reducing associated travel costs.

Further, the operations can include exchanging data with remote computing systems that are configured to use maps and information about locations on the maps to provide more effective navigation information. However, the types of operations that are performed and the way in which the operations are performed can vary over time, as can the underlying hardware that implements the operations. Accordingly, there exists a demand for more effective ways for the user to navigate a geographic area while reducing travel costs and increasing the value derived from expenditures along the way.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of navigation. The computer-implemented method can include accessing, by a computing system comprising one or more processors, request data comprising information associated with one or more requests of a user. The computer-implemented method can include determining, by the computing system, based at least in part on the one or more user requests, one or more locations associated with satisfying the one or more requests. The computer-implemented method can include determining, by the computing system, one or more routes associated with the one or more locations that satisfy the one or more user requests. The computer-implemented method can include determining, by the computing system, one or more completion costs associated with satisfying the one or more requests at the one or more locations. The computer-implemented method can include selecting, by the computing system, based at least in part on one or more travel criteria, a travel route from the one or more routes. The one or more travel criteria can be associated with the one or more completion costs of each of the one or more routes. The computer-implemented method can include generating, by the computing system, output comprising one or more indications associated with the travel route.

Another example aspect of the present disclosure is directed to one or more tangible non-transitory computer-readable media storing computer-readable instructions that when executed by one or more processors cause the one or more processors to perform operations. The operations can include accessing request data comprising information associated with one or more requests of a user. The operations can include determining, based at least in part on the one or more user requests, one or more locations associated with satisfying the one or more requests. The operations can include determining one or more routes associated with the one or more locations that satisfy the one or more user requests. The operations can include determining one or more completion costs associated with satisfying the one or more requests at the one or more locations. The operations can include selecting, based at least in part on one or more travel criteria, a travel route from the one or more routes. The one or more travel criteria can be associated with the one or more completion costs of each of the one or more routes. The operations can include generating output comprising one or more indications associated with the travel route.

Another example aspect of the present disclosure is directed to a computing system that can include: one or more processors; and one or more tangible non-transitory computer-readable media storing instructions that when executed by the one or more processors cause the one or more processors to perform operations. The operations can include accessing request data comprising information associated with one or more requests of a user. The operations can include determining, based at least in part on the one or more user requests, one or more locations associated with satisfying the one or more requests. The operations can include determining one or more routes associated with the one or more locations that satisfy the one or more user requests. The operations can include determining one or more completion costs associated with satisfying the one or more requests at the one or more locations. The operations can include selecting, based at least in part on one or more travel criteria, a travel route from the one or more routes. The one or more travel criteria can be associated with the one or more completion costs of each of the one or more routes. The operations can include generating output comprising one or more indications associated with the travel route.

Other example aspects of the present disclosure are directed to other methods, systems, devices, apparatuses, or tangible non-transitory computer-readable media for navigation.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram of an example system according to example embodiments of the present disclosure.

FIG. 2 depicts a diagram of an example device according to example embodiments of the present disclosure.

FIG. 3 depicts an example of route determination according to example embodiments of the present disclosure.

FIG. 4 depicts an example of a navigation device according to example embodiments of the present disclosure.

FIG. 5 depicts an example of a navigation device according to example embodiments of the present disclosure.

FIG. 6 depicts a flow diagram of cost based navigation and route planning according to example embodiments of the present disclosure.

FIG. 7 depicts a flow diagram of cost based navigation and route planning according to example embodiments of the present disclosure.

FIG. 8 depicts a flow diagram of cost based navigation and route planning according to example embodiments of the present disclosure.

FIG. 9 depicts a flow diagram of cost based navigation and route planning according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to a navigation system that can be used to plan travel routes on the basis of completion costs associated with the price of goods and services available at locations along the travel routes. In particular, the disclosed technology can be used to generate a travel route to a destination based on the minimization of costs of goods or services that a user wishes to purchase. For example, a route can be generated on the basis of a route that minimizes a combination of the price of goods or services as well as the length or duration of the journey. As such, the disclosed technology allows a user to efficiently purchase goods and services while also conserving time and reducing the total expenditures associated with acquiring the goods and services (e.g., fuel costs plus the costs of the goods and services).

The disclosed technology can be implemented in a computing system (e.g., a navigation computing system) that is configured to access data, perform operations on the data (e.g., route determination, and/or completion), and generate output including indications associated with a travel route that minimizes time and costs. Further, the computing system can be included in a vehicle (e.g., an in-vehicle navigation system) or as part of a system that includes a navigation server that receives request data (e.g., a current location and destination) from a client device (e.g., a smart phone) and performs operations based on the requested data and sends output including a planned route back to the client device.

The navigation computing system can access data which can include request data. The request data can include information associated with one or more requests of a user. For example, the request data can include a latitude, longitude, and/or altitude associated with a location of the navigation computing system and/or the user. The one or more user requests can include one or more requests for one or more goods and/or one or more requests for one or more services. For example, the one or more requests can include a requested grocery item (e.g. milk and/or bread) and/or services (e.g., a haircut).

Further, the request data can include information associated with one or more maps of a geographic area within a predetermined distance of the navigation computing system and/or the user. The request data can include the location of one or more roads (e.g., streets, highways, foot paths), bodies of water (lakes, ponds), waterways (rivers, canals), buildings including stores and other locations at which purchases of goods or services can be made. The one or more requests of the user can include one or more requests for one or more goods (e.g., grocery items, electronics, clothing, and/or books) and/or services (e.g., hair styling services, massage therapy, and/or medical services) that the user can purchase. In some embodiments, the one or more requests can be part of a shopping list that is included in the request data.

The navigation computing system can determine one or more locations associated with satisfying the one or more requests. For example, the navigation computing system can determine the one or more locations that include one or more items included in the one or more requests of the user. Determining the one or more locations can include accessing data associated with the one or more items at the one or more locations and comparing the one or more items to the one or more items in the one or more requests. The one or more locations that include the one or more items that match the one or more items of the one or more requests can be included in the one or more locations.

The navigation computing system can determine one or more completion costs. The one or more completion costs can be respectively associated with satisfying the one or more requests at the one or more locations. For example, the computing system can determine an estimated travel time, estimated travel distance, and estimated cost of goods or services, that is associated with sets of the one or more locations that can satisfy the one or more requests of the user (e.g., the locations at which the goods or services requested by the user are available). The one or more completion costs can then be determined based at least in part on an estimated distance, estimated travel time, and/or estimated costs of goods or services associated with sets of the one or more locations. Further, the one or more completion costs can be correlated with the estimated distance, estimated travel time, and/or estimated costs (e.g., total cost of goods or services) associated with each set of the one or more locations.

Furthermore, the one or more completion costs are based at least in part on one or more costs of goods available at the one or more locations, one or more costs of services available at the one or more locations, and/or one or more costs of travelling to the one or more locations. For example, the one or more completion costs can be associated with the expenditures of time and resources that result from travelling to the one or more locations and/or purchasing goods or services at some of the one or more locations. Further, the one or more completion costs can be associated with and/or based at least in part on any of the costs associated with travelling from the user's current location to the one or more locations. The costs that determine the one or more completion costs can include: costs associated with: the amount of time and/or distance to travel to the one or more locations; and/or an amount of fuel and/or energy (e.g., energy consumed by an electric vehicle).

The navigation computing system can determine one or more routes. The one or more routes can include the one or more routes associated with the one or more locations that satisfy the one or more user requests. Each of the one or more routes can include a starting location (e.g., the user's current location) and a destination (e.g., a last location of the one or more locations) that the user can travel to. For example, one or more routes can be determined by accessing the request data and determining a set of roads that traverses the one or more locations.

In some embodiments, the one or more routes can be constrained by one or more route constraints that constrain the one or more routes based at least in part on the cost of one or more goods or one or more services at the one or more locations of the one or more routes. For example, the one or more constraints can include a currency (e.g., dollar) amount that limits the amount of money that will be spent on the one or more items at some combination of the one or more locations.

Further, one or more travel criteria can include a threshold route distance, a threshold route travel time, and/or threshold amount of fuel and/or energy that can be expended to traverse the travel route. The threshold route distance can include a maximum travel distance based at least in part on a distance that covers the one or more locations associated with the travel route. For example, the navigation system can constrain the one or more routes based at least in part on a maximum travel distance that is a function of the total route distance and/or the distance between one or more locations of the travel route.

The threshold route travel time can include a maximum travel time based at least in part on an estimated travel time between the starting location and the destination. For example, the navigation system can constrain the travel route based at least in part on a maximum travel amount of time that the user has indicated in their preferences, and/or a maximum amount of time per item on the user's shopping list.

In some embodiments, the one or more travel criteria can include the aggregate of the one or more completion costs of the travel route being less than a completion cost threshold and/or the aggregate of the one or more completion costs of the travel route being less than any other route of the one or more routes. For example, the one or more travel criteria can require that the selected travel route has an aggregate completion cost that does not exceed the completion cost threshold.

In some embodiments, each of the one or more routes can be respectively associated with a set of the one or more aggregate completion costs comprising a summation of the one or more completion costs. Further, satisfying the one or more travel criteria can include the travel route being associated with a lowest one of the one or more aggregate completion costs. For example, the route with the lowest aggregate completion cost can be selected as the travel route.

Determining the one or more routes can include accessing item data stored on one or more remote computing systems associated with the one or more locations. The item data can include information associated with one or more items available at the one or more locations. For example, the item data can include a milk item indicating one or more prices of milk at the one or more locations.

Further, determining the one or more routes can include determining, based at least in part on the item data, the one or more locations at which the one or more items that will satisfy the one or more requests are available. In this regard, the present disclosure contemplates utilizing merchant inventory data to determine if items are available. Such data can be provided through a common API interface or can be crowdsourced through customer receipts or data entry. For example, customers of merchants can scan or otherwise capture images of receipts associated with such merchants and such information can be utilized to assist in ascertain item availability from such merchants. For example, the computing system can access the item data associated with availability of milk at each of the one or more locations. The one or more locations that do not include milk may not be included in the one or more routes.

In some embodiments, the one or more routes can be based at least in part on the availability of one or more goods and/or one or services at the one or more locations of the one or more routes. For example, the one or more routes can be determined to include the one or more routes including the one or more locations at which at least one of the one or more goods and/or one or more services associated with the one or more requests of the user are available. Further, the one or more routes that are not able to satisfy all of the one or more requests can be discarded. In certain aspects of the present disclosure, availability of one or more goods and/or one or more services can be determined in real-time and such availability can dynamically update the one or more routes.

The navigation computing system can determine, generate, and/or select a travel route based at least in part on the one or more routes. The travel route can be selected and/or determined based at least in part on the one or more completion costs and/or one or more travel criteria. For example, the navigation computing system can select a travel route from the one or more routes. Further, the selected travel route can be a travel route that has a lowest aggregate completion cost. For example, the total cost of travelling to the one or more locations and purchasing the one or more items associated with the one or more requests of the user can be the lowest among the available routes in which the items are available. In some embodiments, the one or more travel criteria can be associated with travel preferences (e.g., a preference to prioritize saving money on goods and/or services over spending more time to obtain the goods).

In some embodiments, selection and/or determination of the travel route can be based at least in part on minimization of some combination of the one or more completion costs. For example, the travel route can be the route of the one or more routes that is associated with a combination (e.g., a weighted combination) of the one or more locations that are associated with the lowest aggregate completion costs including fuel expenditures, goods and services expenditures, and a cost associated with the amount of time to traverse the travel route which can include estimated waiting times at each of the one or more locations associated with the travel route.

In some embodiments, the one or more travel criteria can be based at least in part on one or more preferences associated with the one or more completion costs. For example, the one or more travel criteria can be based at least in part on a weighting of completion costs in which some of the completion costs are more heavily weighted (e.g., a sixty percent (60%) weighting associated with the time costs) than the other completion costs (e.g., a forty percent (40%) weighting associated with the cost of goods or services and fuel).

In some embodiments, the one or more travel criteria can be based at least in part on a determination of one or more user preferences. For example, a user can provide data indicating the user's particular preference with respect to the amount of time to traverse the travel route, the cost of goods and/or services, and/or the cost of fuel to traverse the travel route.

Further, a weighting of the one or more completion costs can be adjusted based at least in part on the one or more user preferences. For example, a user preference can indicate that reduced fuel expenditure is the highest priority with a ninety percent (90%) weighting such that the costs associated with fuel expenditure can have the largest impact on the eventual travel route (e.g., the route with the lowest estimated fuel expenditure will be the travel route).

In some embodiments, the travel route can include a starting location and a destination. Further, the travel route can include a current location of the user, a current location of the navigation computing device/system and/or the one or more locations. Satisfying the one or more travel criteria can include the travel being contiguous between the starting location and the destination. For example, satisfying the one or more travel criteria can include the travel route being a drivable set of roads in which all road segments of the travel route between the starting location to the destination are contiguous.

In some embodiments, the selection of the travel route can be based at least in part on the use of a greedy algorithm. For example, a greedy algorithm can be applied to the one or more routes in order to determine the travel route.

In some embodiments, the one or more completion costs can be based at least in part on one or more travel times and/or one or more travel distances associated with the one or more routes. Further, the one or more completion costs are positively correlated with an estimated distance to the one or more locations and/or an estimated travel time to the one or more locations. For example, the one or more completion costs can be positively correlated with the travel distance and/or travel time (e.g., the one or more completion costs are greater when the estimated travel time and/or travel distance is greater).

The navigation computing system can receive image data including an image of an object captured by the user. For example, the navigation computing system can access locally stored image data that includes an image captured by a camera of a smartphone of the user.

The navigation computing system can determine, based at least in part on the image and one or more machine-learned models, one or more goods and/or one or more services associated with the object. For example, the one or more machine-learned models can be configured and/or trained to recognize one or more objects. The image data can be used as an input that the one or more machine-learned models will perform operations including generating an object recognition output including the one or more goods and/or services associated with the object. For example, an image of a chocolate bar can be used to determine the type of chocolate bar and/or the one or more locations at which the chocolate bar is available.

The navigation computing system can generate output. The output can include one or more indications associated with the travel route. In some embodiments, the output can include one or more indications associated with directions to follow the travel route. For example, the one or more indications can include one or more visual indications (e.g., a map of the geographic area including a travel route between the user's current location and the one or more locations of the travel route) and/or one or more aural indications (e.g., aural instructions indicating the one or more locations of the travel route). By way of further example, the one or more indications can include a graphical user interface that shows a map of a geographic area including the user's current location and the one or more locations included in the travel route.

In some embodiments, the output can include a user interface. Further, the one or more indications can include the one or more completion costs associated with each of the one or more routes. For example, the user interface included in the output can include a map of a geographic area and can include the costs of goods and/or services at each of the one or more locations along the travel route. Further, the user interface can be configured so that the user can accept or reject the travel route. If the travel route is rejected, another travel route that is different from the rejected travel route can be generated.

The disclosed technology can include a computing system (e.g., the navigation computing system) that is configured to perform various operations associated with processing request data and generating travel routes. In some embodiments, the navigation computing system can be associated with various computing systems and/or devices that use, send, receive, and/or generate routes and/or indications associated with the travel routes. Furthermore, the navigation computing system can process, generate, modify, and/or access (e.g., send, and/or receive) data and/or information including request data and/or information associated with generated routes including maps of one or more geographic regions.

The navigation computing system can include specialized hardware and/or software that enable the performance of one or more operations specific to the disclosed technology. The navigation computing system can include one or more application specific integrated circuits that are configured to perform operations associated with accessing request data that includes user requests, determining locations that satisfy the user requests, determining completion costs based on the locations, determining routes associated with the locations that satisfy the user requests, determining a travel route, and generating output including a route for a user based on the completion costs.

The systems, methods, devices, apparatuses, and tangible non-transitory computer-readable media in the disclosed technology can provide a variety of technical effects and benefits including an improvement in travel route planning. In particular, the disclosed technology may assist a user (e.g. a user of a navigation device) in performing technical tasks by means of a continued and/or guided human-machine interaction process in which a travel route is provided to a user, based at least in part on completion costs associated with satisfying a user's requests and/or the user's preferences. The disclosed technology thus may provide an improved real-time route-guidance information to a user in dependence on the user's real-world position.

Furthermore, the disclosed technology may also provide additional benefits including improvements in resource usage efficiency and reduced environmental impact.

The disclosed technology can improve the efficiency of resource consumption (e.g., energy consumed by user devices) by generating travel routes that allow a user to complete their purchases of goods and services along a route that can be optimized to reduce travel time and distance.

The disclosed technology can also be used to reduce the environmental impact (e.g., adverse environmental impact) on an area by minimizing one or more completion costs associated with travelling to locations in order to complete purchases. For example, a completion cost can be associated with the amount of vehicle exhaust (and thereby the amount of pollution) resulting from travel along a travel route (e.g., greater travel distance and/or travel time can be associated with a greater amount of vehicle exhaust). The disclosed technology can be used to reduce the amount of pollution that is associated with travel along a travel route.

As such, the disclosed technology may assist the user of a navigation device in more effectively performing a variety of tasks with the specific benefits of reduced resource consumption and reduced environmental impact. Further, any of the specific benefits provided to users can be used to improve the effectiveness of a wide variety of devices and services including navigation devices and/or navigation services that provide navigational routes. Accordingly, the improvements offered by the disclosed technology can result in tangible benefits to a variety of devices and/or systems including mechanical, electronic, and computing systems associated with navigation and/or providing travel routes for use in navigation.

With reference now to the Figures, example embodiments of the present disclosure will be discussed in further detail.

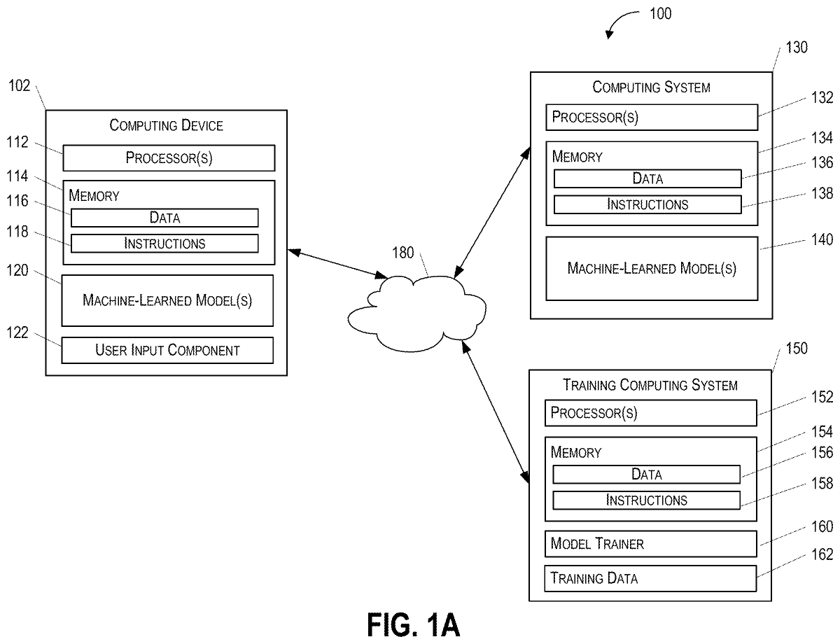

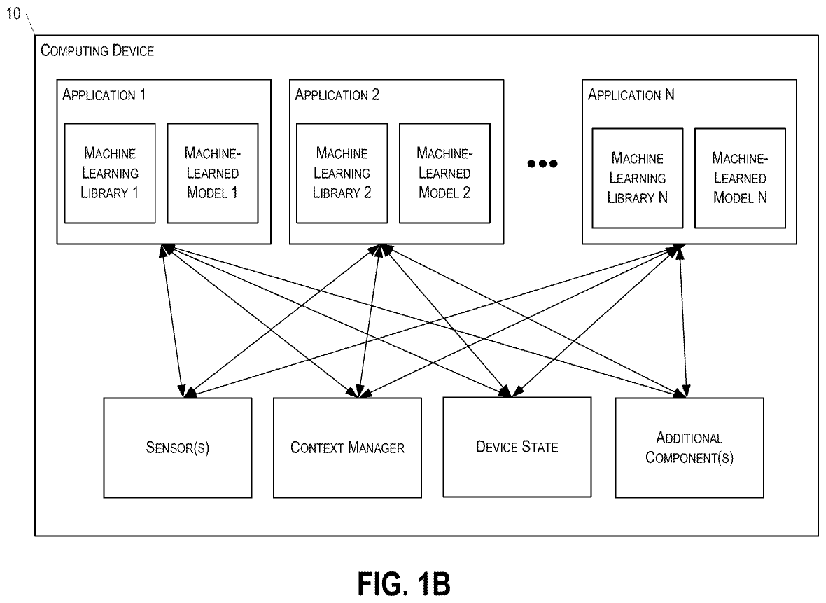

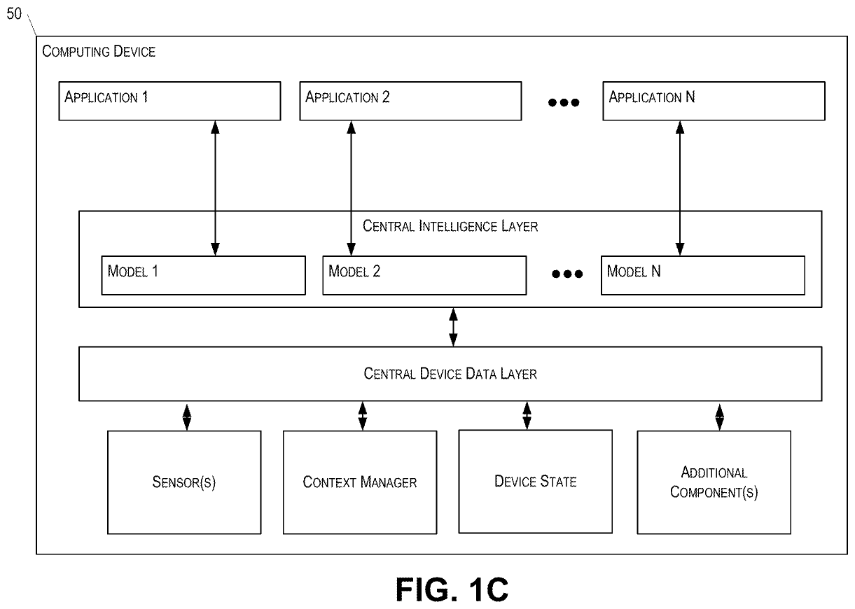

FIG. 1A depicts a block diagram of an example of a computing system 100 that performs operations associated with navigation according to example embodiments of the present disclosure. The system 100 includes a computing device 102, a computing system 130 (e.g., a server computing system 130), and a training computing system 150 that are communicatively coupled over a network 180.

The computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store the data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-9.

In some implementations, the one or more machine-learned models 120 can be received from the computing system 130 over network 180, stored in the memory 114, and then used or otherwise implemented by the one or more processors 112. In some implementations, the computing device 102 can implement multiple parallel instances of a single machine-learned model 120.

More particularly, the one or more machine-learned models 120 can be configured and/or trained to perform operations including accessing request data that includes user requests, determining locations that satisfy the user requests, determining completion costs based on the locations, determining routes associated with the locations that satisfy the user requests, determining a travel route, and generating output including a route for a user based on the completion costs.

Additionally, or alternatively, one or more machine-learned models 140 can be included in or otherwise stored and implemented by the computing system 130 that communicates with the computing device 102 according to a client-server relationship. For example, the one or more machine-learned models 140 can be implemented by the server computing system 130 as a portion of a web service (e.g., a navigation service that manages request data and determines completion costs). Thus, one or more machine-learned models 120 can be stored and implemented at the computing device 102 and/or one or more machine-learned models 140 can be stored and implemented at the server computing system 130.

The computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the computing system 130 to perform operations.

In some implementations, the computing system 130 includes or is otherwise implemented by one or more server computing devices. In instances in which the computing system 130 includes plural server computing devices, such server computing devices can operate according to sequential computing architectures, parallel computing architectures, or some combination thereof.

As described above, the computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1A-9.

The computing device 102 and/or the computing system 130 can train the one or more machine-learned models 120 and/or 140 via interaction with the training computing system 150 that is communicatively coupled over the network 180. The training computing system 150 can be separate from the computing system 130 or can be a portion of the computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the computing device 102 and/or the computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more user requests including prices and/or costs of various combinations of one or more goods and services that could be associated with a user.

In some implementations, if the user has provided consent, the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text and/or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic output associated with the semantic content of a text or natural language input. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a navigation application, a mapping application, a routing application, an e-mail application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example of a computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a navigation application, a mapping application, a routing application, an e-mail application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

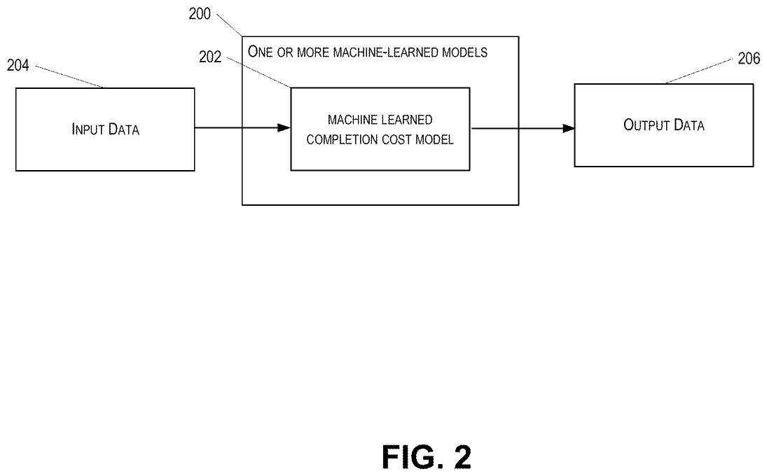

FIG. 2 depicts a block diagram of an example of one or more machine-learned models 200 according to example embodiments of the present disclosure. In some implementations, the one or more machine-learned models 200 are trained to access and/or receive a set of input data 204 descriptive of a user request (e.g., a user request for a user to purchase one or more goods and/or one or more services) and, after performing one or more operations on the input data 204, generating output data 206 that includes information associated with a travel route to purchase the one or more goods and/or one or more services. Thus, in some implementations, the one or more machine-learned models 200 can include a navigation machine-learned model 202 that is operable to generate output associated with indications of locations and times that allow a user to travel more effectively (e.g., shorter travel distance and/or duration).

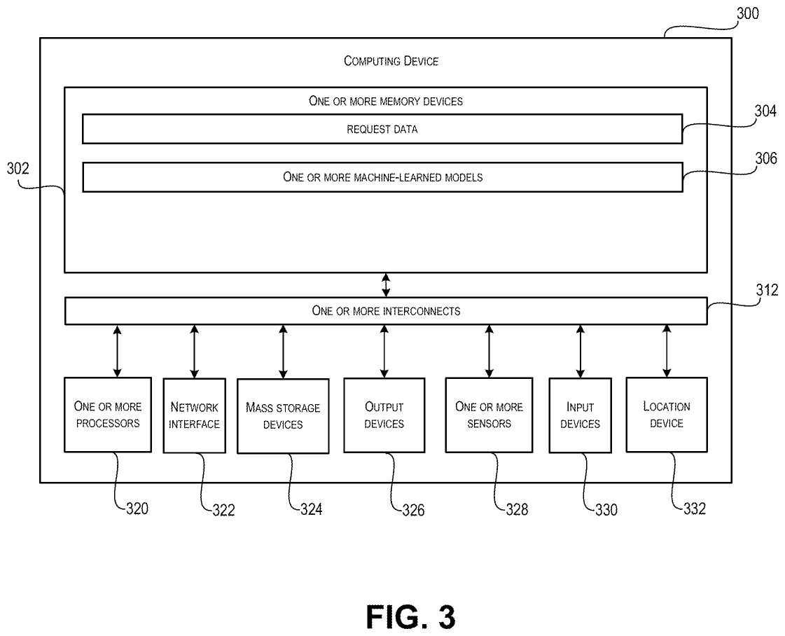

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, request data 304, one or more machine-learned models 306, one or more interconnects 312, one or more processors 320, a network interface 322, one or more mass storage devices 324, one or more output devices 326, one or more sensors 328, one or more input devices 330, and/or the location device 332.

The one or more memory devices 302 can store information and/or data (e.g., the request data 304, and/or the one or more machine-learned models 306). Further, the one or more memory devices 302 can include one or more non-transitory computer-readable storage media, including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with generating one or more indications for navigation by a user.

The request data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the request data 304 can include information associated with one or more requests for a user to purchase one or more goods and/or one or more services that can be implemented on the computing device 300. In some embodiments, the request data 304 can be received from one or more computing systems (e.g., the computing system 130 that is depicted in FIG. 1) which can include one or more computing systems that are remote (e.g., in another room, building, part of town, city, or nation) from the computing device 300.

The one or more machine-learned models 306 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can include information associated with performing operations including accessing request data that includes user requests, determining locations that satisfy the user requests, determining completion costs based on the locations, determining routes associated with the locations that satisfy the user requests, determining a travel route, and generating output including a route for a user based on the completion costs. In some embodiments, the one or more machine-learned models 306 can be received from one or more computing systems (e.g., the computing system 130) that is depicted in FIG. 1) which can include one or more computing systems that are remote from the computing device 300.

The one or more interconnects 312 can include one or more interconnects or buses that can be used to send and/or receive one or more signals (e.g., electronic signals) and/or data (e.g., the request data 304 and/or the one or more machine-learned models 306) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 312 can be arranged or configured in different ways including as parallel or serial connections. Further the one or more interconnects 312 can include one or more internal buses to connect the internal components of the computing device 300; and one or more external buses used to connect the internal components of the computing device 300 to one or more external devices. By way of example, the one or more interconnects 312 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320 can perform one or more actions and/or operations including one or more actions and/or operations associated with the request data 304 and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the request data 304 and/or the one or more machine-learned models 306. The one or more output devices 326 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the indications associated with navigation by the user. The one or more memory devices 302 can be used to operate various applications including a mobile operating system developed specifically for mobile devices. As such, the one or more memory devices 302 can store instructions that allow the software applications to access data including data associated with the generation of indications for navigation by a user. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

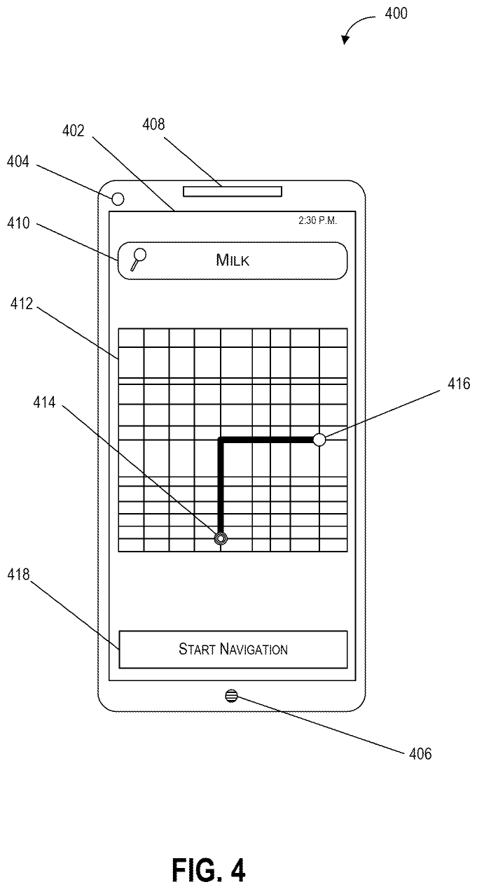

FIG. 4 depicts an example of a navigation device according to example embodiments of the present disclosure. A computing device 400) can include one or more attributes and/or capabilities of the computing device 102, the computing system 130, the training computing system 150, and/or the computing device 300. Furthermore, the computing device 400 can perform one or more actions and/or operations including the one or more actions and/or operations performed by the computing device 102, the computing system 130, the training computing system 150, and/or the computing device 300.

As shown in FIG. 4, the computing device 400 includes a display component 402, an imaging component 404, an audio input component 406, an audio output component 408, an interface element 410, an interface element 412, an interface element 414, an interface element 416, and an interface element 418.

The computing device 400 can be configured to perform one or more operations including accessing, processing, sending, receiving, and/or generating data including request data which can include information associated with one or more goods, one or more services, one or more costs associated with the one or more user requests, one or more locations, and/or one or more maps of one or more geographic areas. Further, the computing device 400 can receive one or more inputs including one or more user inputs from a user of the computing device 400. For example, a user can provide a product the user intends to purchase by entering the name of the product via the interface element 410 which is displayed on the display component 402 that also shows the interface element 414 which indicates the current location of the computing device 400.

In this example, a user has opened a shopping application on the computing device 400 and is searching for milk in the vicinity. The user has entered the search term “MILK” in the interface element 410 which is used to receive user inputs associated with a search for a good or service associated with a user request in a geographic area and is configured to receive one or more inputs including touch inputs (e.g., the user touching characters on a pop-up key board and spelling out the name of a product associated with the user's request) and/or aural inputs (e.g., the user speaking the search term including the type of product).

The computing device 400 can then send data associated with the user's request to a server computing device that includes the locations of the user's requested product and which is able to determine a location that sells milk at the lowest price, which can be represented on the interface element 412 (e.g., a map of the geographic area within a predetermined distance of the computing device 400) which also includes the interface element 414 that indicates the current location of the computing device 400.

Furthermore, in some embodiments, the computing device 400 can generate output including a combination of one or more indications that include one or more locations associated with the one or more requests of the user. For example, the computing device 400 can generate output including the location of the store that sells the milk as indicated by the interface element 416.

The computing device 400 can generate the interface element 418 which indicates “START NAVIGATION.” If the user activates the interface element 418 (e.g., by touching the interface element 418), the computing device can provide navigation indications including a travel route to the location of the store that sells the milk.

In some embodiments, the computing device 400 can use the audio output component 408 to generate an audio output (e.g., a synthetic voice) that provides output including one or more aural indications of the content associated with the interface element 410. For example, the audio output component 408 can generate one or more aural indications indicating “THE LOWEST PRICED MILK IS AVAILABLE 5 MINUTES AWAY.”. Further, the user can provide their response to the computing device 400 via one or more inputs to the audio input component 406 (e.g., a microphone) which can be configured to detect a user's voice. The computing device 400 can then perform one or more voice recognition operations to determine the decision to start navigation based on what the user says in response to the one or more aural indications.

In some embodiments, the computing device 400 can determine a user's chosen course of action based at least in part on use of the imaging component 404 (e.g., a camera). For example, the audio output component 408 can generate one or more aural indications indicating “NOD TO TRAVEL TO THE INDICATED STORE.” The user can then provide their response to the computing device 400 via one or more inputs to the imaging component 404 (e.g., a camera) which can be configured to detect whether the user has nodded.

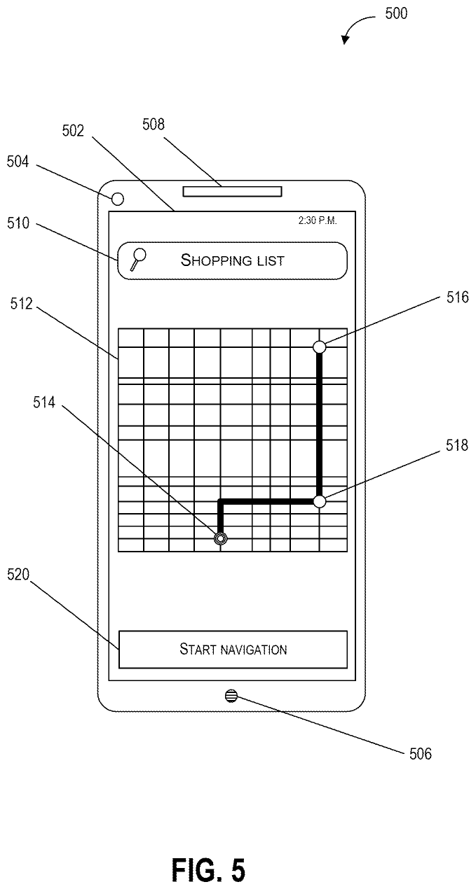

FIG. 5 depicts an example of a navigation device according to example embodiments of the present disclosure. A computing device 500 can include one or more attributes and/or capabilities of the computing device 102, the computing system 130, the training computing system 150, and/or the computing device 300. Furthermore, the computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, an interface element 510, an interface element 512, an interface element 514, an interface element 516, an interface element 518, and an interface element 520.

The computing device 500 can be configured to perform one or more operations including accessing, processing, sending, receiving, and/or generating data including request data which can include information associated with one or more goods, one or more services, one or more costs associated with the one or more user requests, one or more locations, and/or one or more maps of one or more geographic areas. Further, the computing device 500 can receive one or more inputs including one or more user inputs from a user of the computing device 500. For example, a user can provide a product the user intends to purchase by entering the name of the product via the interface element 510 which is displayed on the display component 502 that also shows the interface element 514 which indicates the current location of the computing device 500.

In this example, a user has opened a shopping application on the computing device 500 and is searching for items in the user's shopping list (included in request data) that are available in the area. The user has entered the search term “SHOPPING LIST” in the interface element 510 which is used to receive user inputs associated with a search for a good or service associated with a user request for items in the user's shopping list that are available in a geographic area and is configured to receive one or more inputs including touch inputs (e.g., the user touching characters on a pop-up keyboard and spelling out the name of a product associated with the user's request) and/or aural inputs (e.g., the user speaking the search term including the type of product).

The computing device 500 can then send data associated with the user's request to a server computing device that includes the locations of the items in the user's shopping list and which is able to determine the locations that sell the items in the user's shopping list at the combined lowest price, which can be represented on the interface element 512 (e.g., a map of the geographic area within a predetermined distance of the computing device 500) which also includes the interface element 514 that indicates the current location of the computing device 500.

Furthermore, in some embodiments, the computing device 500 can generate output including a combination of one or more indications that include one or more locations associated with the one or more requests of the user. For example, the computing device 500 can generate output including the interface element 516 and the interface element 518 which show stores that sell the items in the user's shopping list.

The computing device 500 can generate the interface element 520 which indicates “START NAVIGATION.” If the user activates the interface element 520 (e.g., by touching the interface element 520), the computing device can provide navigation indications including a travel route to the location of the store that sells the milk.

In some embodiments, the computing device 500 can use the audio output component 508 to generate an audio output (e.g., a synthetic voice) that provides output including one or more aural indications of the user request associated with the interface element 510. For example, the audio output component 508 can generate one or more aural indications indicating “THE LOCATIONS OF THE LOWEST PRICED COMBINATION OF ITEMS ON YOUR SHOPPING LIST ARE BEING SHOWN”. Further, the user can provide their response to the computing device 500 via one or more inputs to the audio input component 506 (e.g., a microphone) which can be configured to detect a user's voice. The computing device 500 can then perform one or more voice recognition operations to determine the decision to start navigation based on what the user says in response to the one or more aural indications.

In some embodiments, the computing device 500 can determine a user's chosen course of action based at least in part on use of the imaging component 504 (e.g., a camera). For example, the audio output component 508 can generate one or more aural indications indicating “NOD TO TRAVEL TO THE INDICATED STORES.” The user can then provide their response to the computing device 500 via one or more inputs to the imaging component 504 (e.g., a camera) which can be configured to detect whether the user has nodded.

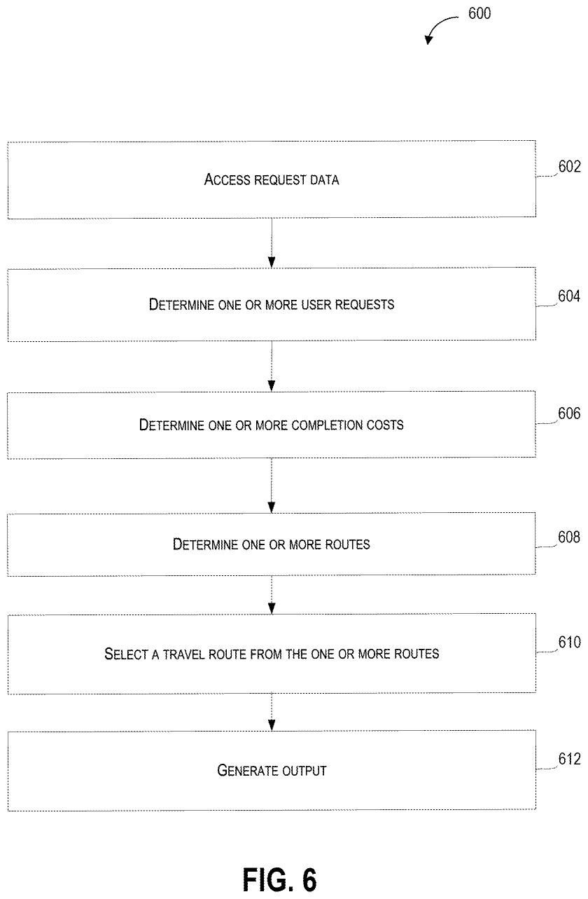

FIG. 6 depicts a flow diagram of cost based navigation and route planning according to example embodiments of the present disclosure. One or more portions of the method 600 can be executed and/or implemented on one or more computing devices or computing systems including, for example, the computing device 102, the computing system 130, the training computing system 150, and/or the computing device 300. Further, one or more portions of the method 600 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include accessing request data. The request data can include information associated with one or more requests of a user. Further, the request data can include information associated with one or more locations that can include one or more locations that sell goods or services included in the one or more requests.

For example, the computing device 102 (e.g., a navigation device) can access request data including a shopping list of items that the user intends to purchase.

At 604, the method 600 can include based at least in part on the one or more user requests, one or more locations associated with satisfying the one or more requests.

For example, the computing device 102 can access a geographic information system that includes information associated with items for sale at one or more locations in a geographic area. The computing device 102 can then determine the one or more locations at which the one or more items included in the one or more requests are available.

At 606, the method 600 can include determining one or more completion costs respectively associated with satisfying the one or more requests at the one or more locations. For example, the computing device 102 and/or the computing system 130 can determine the one or more completion costs based at least in part on any of the costs (e.g., prices of goods or services) associated with the one or more stores along each of the one or more routes. In some embodiments, the one or more completion costs can be weighted and/or averaged.

At 608, the method 600 can include determining one or more routes associated with the one or more locations that satisfy the one or more user requests. For example, the computing device 102 and/or the computing system 130 can access the request data, which can include information associated with locations in the geographic area and determine routes between the current location of the user and the one or more locations.

At 610, the method 600 can include selecting, based at least in part on one or more travel criteria, a travel route from the one or more routes. The one or more travel criteria are associated with the one or more completion costs of each of the one or more routes. selecting and/or determining one or more travel routes (e.g., a travel route) from the one or more routes. Selection and/or determination of the travel route can be based at least in part on the one or more completion costs. Further, the one or more travel criteria can be associated with one or more travel preferences (e.g., one or more travel preferences of a user that will be travelling along the travel route). By way of example, the computing device 102 can, for each of the one or more routes, determine an aggregate completion cost based on the completion costs for the one or more locations included in the one or more routes. The one or more routes can then be ranked according to their respective aggregate costs. Further, the one or more travel criteria can be applied to the one or more routes and the travel route can be based at least in part on the travel route of the one or more routes that satisfies the one or more travel criteria and has the lowest aggregate cost (e.g., the lowest combination of the one or more completion costs associated with goods and services prices, travel time, travel duration, and/or fuel expenditure).

At 612, the method 600 can include generating output. The output can include information associated with associated with the travel route. Further, the output can include information associated with one or more indications that can be based at least in part on the travel route. Furthermore, the output can include information associated with: one or more locations of the one or more locations that can satisfy the one or more user requests.

By way of example, the computing device 102 can generate output that includes information associated with a map of the area including the travel route and locations at which stores that can satisfy the requests of the user have the user requested goods and/or services available.

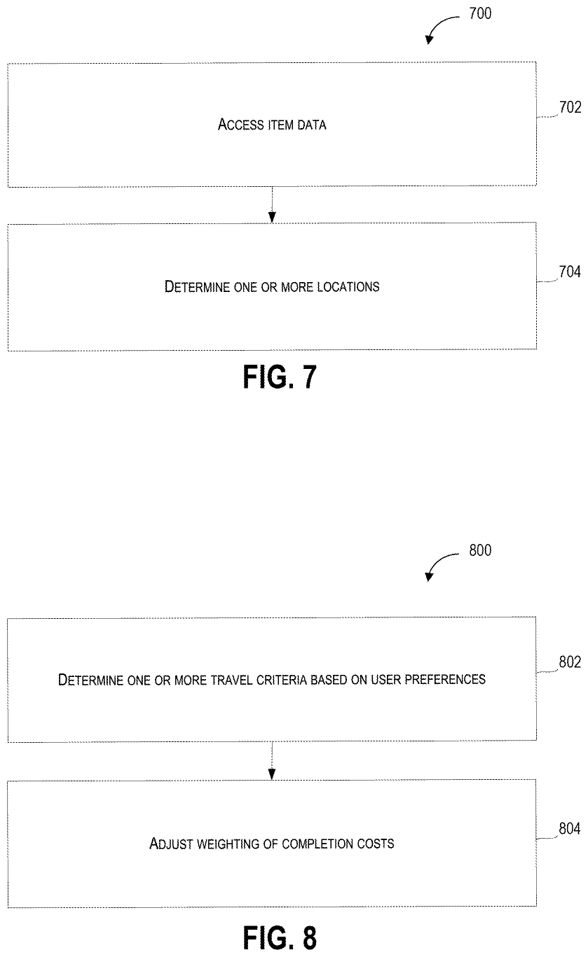

FIG. 7 depicts a flow diagram of cost based navigation and route planning according to example embodiments of the present disclosure. One or more portions of the method 700 can be executed and/or implemented on one or more computing devices or computing systems including, for example, the computing device 102, the computing system 130, the training computing system 150, and/or the computing device 300. Further, one or more portions of the method 700 can be executed or implemented as an algorithm on the hardware devices or systems disclosed herein. In some embodiments, one or more portions of the method 700 can be performed as part of the method 600 that is depicted in FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include accessing item data stored on one or more remote computing systems associated with the one or more locations. The item data can include information associated with one or more items available at the one or more locations. For example, the computing device 102 can access item data including a shopping list of a user that is stored on a remote computing device.

At 704, the method 700 can include determining, based at least in part on the item data, the one or more locations at which the one or more items that will satisfy the one or more requests are available. For example, the computing device 102 can analyze the item data and determine the one or more items of the item data that match the one or more requests of the request data.

FIG. 8 depicts a flow diagram of cost based navigation and route planning according to example embodiments of the present disclosure. One or more portions of the method 800 can be executed and/or implemented on one or more computing devices or computing systems including, for example, the computing device 102, the computing system 130, the training computing system 150, and/or the computing device 300. Further, one or more portions of the method 800 can be executed or implemented as an algorithm on the hardware devices or systems disclosed herein. In some embodiments, one or more portions of the method 800 can be performed as part of the method 600 that is depicted in FIG. 6. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining the one or more travel criteria. The one or more travel criteria can be based at least in part on one or more user preferences. For example, the computing device 102 can access user preference data that includes information associated with the specific preferences of a user with respect to factors including the time and distance of travel. The user preference data can include information associated with a distance factor associated with an upper limit for the distance of a travel route or an upper limit for a time of travel along a travel route.

In some embodiments, the one or more user preferences can be stored on a computing device personally used or authorized by the user (e.g., the computing device 102) and not provided to other systems and/or devices that are not used or authorized by the user. Further, the one or more user preferences can be encrypted and/or anonymized in a privacy enhancing way that, without the consent of the user, does not publicly disclose the identity of the user, the location of the user, and/or personal information associated with the user.

At 804, the method 800 can include adjusting a weighting of the one or more completion costs. Adjustment of the weighting of the one or more completion costs can be based at least in part on the one or more user preferences. For example, the computing device 102 can access user preference data that indicates that the associated user prioritizes reduced item costs over the duration of travel. The computing device 102 can then increase the weighting so that lower item prices are more determinative of the travel route that is determined and/or selected (e.g., the user values cost savings over time savings).

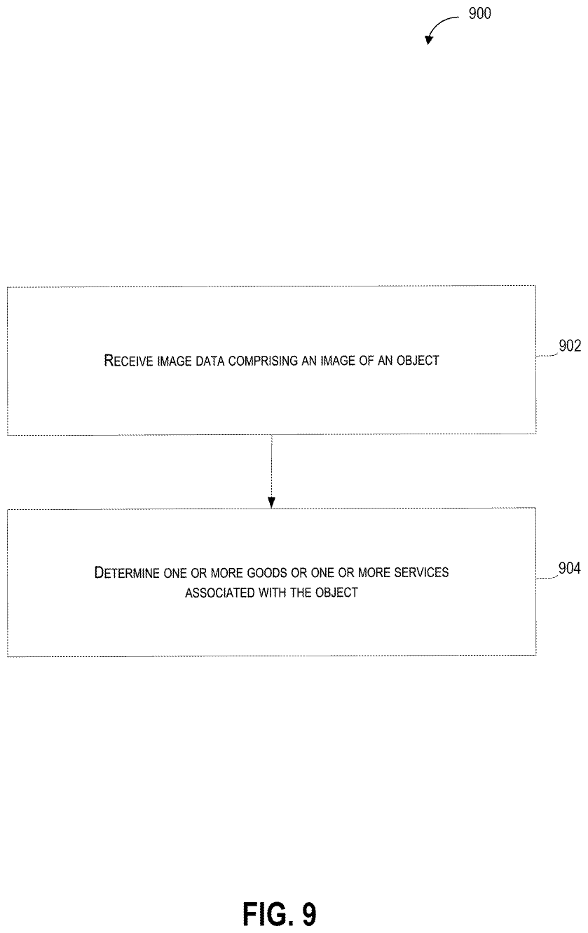

FIG. 9 depicts a flow diagram of cost based navigation and route planning according to example embodiments of the present disclosure. One or more portions of the method 900 can be executed and/or implemented on one or more computing devices or computing systems including, for example, the computing device 102, the computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 600 that is depicted in FIG. 6. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving image data including an image of an object captured by the user. For example, the computing device 102 can access locally stored image data that includes an image captured by a camera of the computing device 102.

At 904, the method 900 can include determining, based at least in part on the image and one or more machine-learned models, one or more goods and/or one or more services associated with the object. The one or more requests can be based at least in part on the one or more goods or one or more services. For example, the computing device 102 can use image recognition techniques to recognize the object and then access a database of goods and services to associate the object with the requested good or service.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of navigation, the computer-implemented method comprising:
accessing, by a computing system comprising one or more processors, request data comprising information associated with one or more requests of a user;
determining, by the computing system, based at least in part on the one or more user requests, one or more locations associated with satisfying the one or more requests;
determining, by the computing system, one or more routes associated with the one or more locations that satisfy the one or more user requests;
determining, by the computing system, one or more completion costs associated with satisfying the one or more requests at the one or more locations;
selecting, by the computing system, based at least in part on one or more travel criteria, a travel route from the one or more routes, wherein the one or more travel criteria are associated with the one or more completion costs of each of the one or more routes; and
generating, by the computing system, output comprising one or more indications associated with the travel route.

2. The computer-implemented method of claim 1, wherein the one or more completion costs are based at least in part on one or more costs of goods available at the one or more locations, one or more costs of services available at the one or more locations, or one or more costs of travelling to the one or more locations.

3. The computer-implemented method of claim 1, wherein the one or more completion costs are positively correlated with an estimated distance to the one or more locations or an estimated travel time to the one or more locations.

4. The computer-implemented method of claim 1, wherein the one or more user requests comprise one or more requests for one or more goods and/or one or more requests for one or more services.

5. The computer-implemented method of claim 1, wherein the one or more travel criteria comprise an aggregate of the one or more completion costs of the travel route being less than a completion cost threshold or an aggregate of the one or more completion costs of the travel route being less than any other route of the one or more routes.

6. The computer-implemented method of claim 1, wherein the determining, by the computing system, one or more routes associated with the one or more locations that satisfy the one or more user requests comprises:
accessing, by the computing system, item data stored on one or more remote computing systems associated with the one or more locations, wherein the item data comprises information associated with one or more items available at the one or more locations; and
determining, by the computing system, based at least in part on the item data, the one or more locations at which the one or more items that will satisfy the one or more requests are available.

7. The computer-implemented method of claim 1, wherein the one or more travel criteria are based at least in part on one or more preferences associated with the one or more completion costs.

8. The computer-implemented method of claim 1, further comprising:
determining, by the computing system, the one or more travel criteria based at least in part on one or more user preferences; and
adjusting, by the computing system, a weighting of the one or more completion costs based at least in part on the one or more user preferences.

9. The computer-implemented method of claim 1, wherein the travel route comprises a starting location and a destination, the travel route being contiguous between the starting location and the destination.

10. The computer-implemented method of claim 1, wherein the one or more completion costs are based at least in part on one or more travel times or one or more travel distances associated with the one or more routes.

11. The computer-implemented method of claim 1, wherein the one or more travel criteria comprise a threshold route distance or a threshold route travel time.

12. The computer-implemented method of claim 1, wherein the one or more routes are constrained by one or more route constraints that constrain the one or more routes based at least in part on the cost of one or more goods and/or one or more services at the one or more locations of the one or more routes.

13. The computer-implemented method of claim 1, further comprising:
receiving, by the computing system, image data comprising an image of an object captured by the user; and
determining, by the computing system, based at least in part on the image and one or more machine-learned models, one or more goods and/or one or more services associated with the object, wherein the one or more requests are based at least in part on the one or more goods and/or one or more services.

14. The computer-implemented method of claim 1, wherein each of the one or more routes is respectively associated with a set of the one or more aggregate completion costs comprising a summation of the one or more completion costs, and wherein the route associated with a lowest one of the one or more aggregate completion costs is selected by the computer system as the travel route.

15. One or more tangible non-transitory computer-readable media storing computer-readable instructions that when executed by one or more processors cause the one or more processors to perform operations, the operations comprising:
accessing request data comprising information associated with one or more requests of a user;
determining, based at least in part on the one or more user requests, one or more locations associated with satisfying the one or more requests;
determining one or more routes associated with the one or more locations that satisfy the one or more user requests;
determining one or more completion costs associated with satisfying the one or more requests at the one or more locations;
selecting, based at least in part on one or more travel criteria, a travel route from the one or more routes, wherein the one or more travel criteria are associated with the one or more completion costs of each of the one or more routes; and
generating output comprising one or more indications associated with the travel route.

16. The one or more tangible non-transitory computer-readable media of claim 15, wherein the travel route comprises a current location of the user or the one or more locations.

17. The one or more tangible non-transitory computer-readable media of claim 15, wherein the selection of the travel route is based at least in part on use of a greedy algorithm.

18. A computing system comprising:
one or more processors;
one or more non-transitory computer-readable media storing instructions that when executed by the one or more processors cause the one or more processors to perform operations comprising:
accessing request data comprising information associated with one or more requests of a user;
determining, based at least in part on the one or more user requests, one or more locations associated with satisfying the one or more requests;
determining one or more routes associated with the one or more locations that satisfy the one or more user requests;
determining one or more completion costs associated with satisfying the one or more requests at the one or more locations;
selecting, based at least in part on one or more travel criteria, a travel route from the one or more routes, wherein the one or more travel criteria are associated with the one or more completion costs of each of the one or more routes; and
generating output comprising one or more indications associated with the travel route.

19. The computing system of claim 18, wherein the one or more routes are based at least in part on an availability of one or more goods or one or services at the one or more locations of the one or more routes.

20. The computing system of claim 18, wherein the output comprises a user interface, and wherein the one or more indications comprise the one or more completion costs associated with each of the one or more routes.
